(19) United States
(12) Patent Application Publication
(10) Pub. No.: US 2003/0025305 A1
(43) Pub. Date: Feb. 6, 2003

(54) Air bag cover assembly

(76) Inventors: Phillip Brian Speelman, Miami Township, OH (US); Lajuanda D. Holton, Dayton, OH (US); Mark Brian Wolfe, Vandalia, OH (US); Raymond Christopher Cooley, Middletown, OH (US); Andrew P. Nock, Centerville, OH (US); James John Sommer, Tipp City, OH (US); Ronald F. Widin, Beaver Creek, OH (US)

Correspondence Address: DELPHI TECHNOLOGIES, INC., Legal Staff, Mail Code: 480-414-420, P.O. Box 5052, Troy, MI, 48007-5052, US

(21) Appl. No.: 09/919,100

(22) Filed: Jul. 31, 2001

(51) Int. Cl. B60R 21/16

(52) U.S. Cl. 280/728.2; 280/743.1

(57) ABSTRACT

An air bag cover assembly for use in an instrument panel of an automotive vehicle and including a displaceable door structure which lifts clear of the surrounding cover structure at an initial stage of air bag deployment prior to undergoing tethered rotation by one or more extensible tethering elements thereby substantially avoiding contacting relation between the door structure and adjacent portions of the cover structure and reducing stress on the nonmoving components.

### TECHNICAL FIELD

This invention relates generally to air bag restraint systems for use in transportation vehicles and, more particularly, to a cover assembly including a displaceable door element arranged across a deployment opening within a vehicle panel structure wherein the displaceable door structure is retained in anchored relation to the panel structure upon displacement by an underlying air bag cushion as the underlying air bag cushion emerges through the deployment opening.

### BACKGROUND OF THE INVENTION

It is well known in motor vehicles to provide an air bag module which includes an inflatable air bag cushion for the protection of a vehicle occupant in the event of a collision. The air bag module typically includes an inflator for discharging an inflation medium such as high pressure gas or the like into the air bag cushion upon the occurrence of a predetermined level of vehicle deceleration or other measurable vehicle condition.

Inflatable air bag cushions may be located at a number of locations within the vehicle so as to provide protection for the occupants therein during various collision events. In particular, it is known to utilize an inflatable air bag cushion stored within the hub of the steering wheel for protection of the operator of the vehicle and to utilize an inflatable air bag cushion deployable from the instrument panel for protection of a front seat passenger within the vehicle during a collision event.

It is known in motor vehicles to mount the air bag cushion for protection of the passenger at a location within the instrument panel for deployment through a predefined opening in a single layer or multi-layer instrument panel cover structure. A deployment door is typically disposed across the opening in the instrument panel cover structure in covering relation to the underlying air bag cushion. The deployment door in such structures may be attached by hinge or tether elements to a portion of the instrument panel cover structure outboard of the deployment opening along one side of the door structure so as to cause the door structure to hinge away from the instrument panel as it is pushed out of placement across the deployment opening by the inflating air bag cushion. The hinging or tethering elements are typically arranged along a forward edge of the displaceable door so as to cause the door to rotate in a generally forward direction within the vehicle towards the windshield and away from the occupant to be protected. Several exemplary air bag cover assemblies are illustrated and described in U.S. Pat. No. 6,045,153 to Sommer; U.S. Pat. No. 5,398,959 to Avila; and U.S. Pat. No. 5,238,264 to Barnes all of which are incorporated by reference as if fully set forth herein.

It has been found that in some instances, the door structures in known cover assemblies may tend to rub against opposing adjacent surfaces at the axis of rotation rather than swinging completely free as the door is moved away from the deployment opening. In some instances such interaction may be undesirable due to the fact that additional force may be placed on the nonmoving components of the cover assembly at locations outboard of the deployment opening. In some instances, the supporting substrate panel portion of the cover assembly (also known as the instrument panel retainer) may be damaged.

The air bag cushion is typically stored within a module in conjunction with a gas emitting inflator at a location within the instrument panel below the cover structure. In order to ensure the delivery of the inflating air bag cushion to the underside of the displaceable door, past designs have utilized guide chutes extending from the air bag module towards the door. The guide chute is typically formed as an independent unit and mounted in conjunction with the air bag module at a fixed location below the instrument panel with an open end projecting towards the door. While such assemblies have proven to be effective in the delivery and deployment of the air bag cushion, the mounting arrangements for such structures may be relatively complex. Moreover, the guide chute in such an assembly may be prone to a degree of vibration at its free upper end. Such vibration may give rise to potentially undesirable noise during the latter stages of the vehicle life. In addition, the separate manufacture of the guide chute may tend to add complexity and cost to the manufacturing process.

### SUMMARY OF THE INVENTION

According to one aspect, the present invention provides advantages and alternatives over the prior art by providing an air bag cover assembly including a displaceable door structure which lifts clear of the surrounding cover structure at an initial stage of air bag deployment prior to undergoing tethered rotation thereby substantially avoiding contacting relation between the door structure and adjacent portions of the cover structure and reducing stress on the nonmoving components.

According to another aspect, the present invention provides further advantages and alternatives over the prior art by providing an air bag cover assembly including a guide chute structure formed integrally with a supporting substrate panel within the cover assembly.

According to a potentially preferred embodiment, an air bag cover assembly is provided including a substrate panel having an air bag deployment opening disposed therein, a displaceable door structure disposed across the air bag deployment opening within the substrate panel and a walled guide chute structure including a plurality of walls integrally formed with the substrate panel and extending away from the substrate panel at locations outboard of the air bag deployment opening. At least one of the guide walls includes a tether acceptance opening and a tethering element of extendible operative length is disposed through the tether acceptance opening between a first point of connection on the displaceable door structure and a second point of connection on the substrate panel outboard of the air bag deployment opening.

Preferably, the walled guide chute structure includes a guide wall extending along at least a portion of a forward edge of the displaceable door structure. The guide wall extending adjacent the forward edge of the displaceable door structure includes a multiplicity of slotted openings for acceptance of tethering elements therethrough. Tethering elements of substantially rigid, plastically deformable character extend through the slotted openings to establish anchoring connections between the displaceable door structure and points of connection on the substrate panel outboard and forward of the air bag deployment opening. The tethering elements which may be formed of a metallic material preferably include an integral expansion structure such that upon displacement of the door structure by the underlying air bag cushion the tethering elements are extended to an increased operative length as the door structure is first projected away from the surrounding structure and then rotates towards the windshield of the vehicle.

Other advantages and aspects of the present invention will become apparent through reference to the following detailed description and/or through practice of the invention as described therein.

### BRIEF DESCRIPTION OF THE DRAWINGS

The following drawings which are incorporated in and which constitute a part of this specification illustrate a potentially preferred embodiment of the present invention and, together with the description of the invention given above and the detailed description set forth below, serve to explain the principles of the invention wherein:

FIG. 1 is a perspective view of a vehicle interior including an air bag cover assembly according to the present invention;

FIG. 2 is a cross-sectional view taken along line 2-2 of FIG. 1;

FIG. 3 is a view similar to FIG. 2 illustrating the initial displacement of the panel door structure upon inflation of an underlying air bag cushion;

FIG. 4 is a view similar to FIG. 3 upon displacement of the panel door structure and hinging rotation away from the path of the inflating air bag cushion; and

FIG. 5 is a view taken generally along line 5-5 in FIG. 4 illustrating an arrangement of multiple tethering elements arranged along a forward edge of the air bag deployment opening and extending through slotted apertures within a forward wall of a guide chute between the door structure and a forward portion of the instrument panel.

While the invention has been illustrated and described above and will hereinafter be described in connection with certain potentially preferred embodiments and procedures, it is to be understood that in no event is the invention to be limited to such illustrated and described embodiments and procedures. On the contrary, it is intended that the present invention shall extend to all alternatives and modifications to the illustrated and described embodiments and procedures as may embrace the broad principle of this invention within the true spirit and scope thereof.

### DESCRIPTION OF THE PREFERRED EMBODIMENT

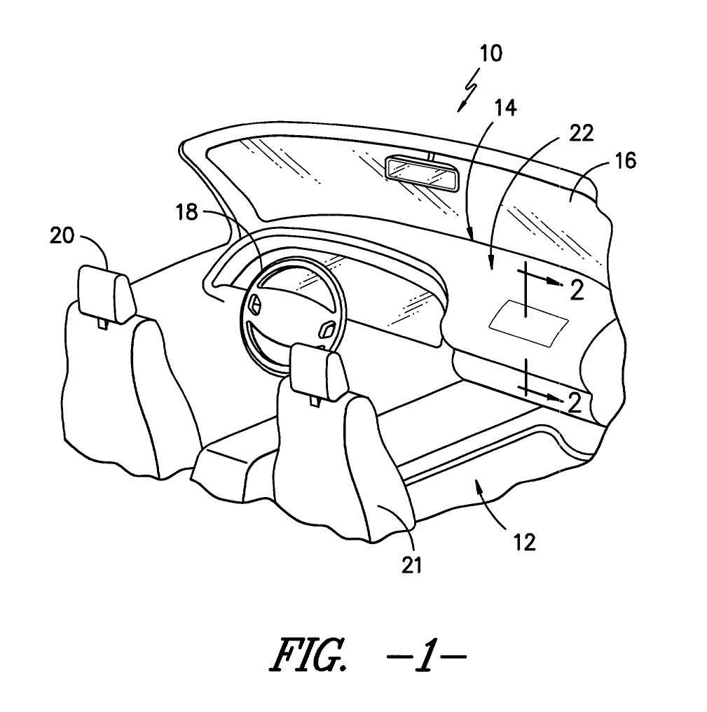

Reference will now be made to the drawings, wherein to the extent possible like reference numerals are utilized to designate like components throughout the various views. In FIG. 1, a vehicle 10 includes a vehicle interior 12 including an instrument panel 14 extending transversely across the vehicle interior 12 rearward of a windshield 16 between the sides of the vehicle 10. The driver's side of the instrument panel 14 includes an instrument cluster and a steering wheel 18 located forward of a driver seat 20. The passenger side of the instrument panel 14 is positioned forward of a passenger seat 21.

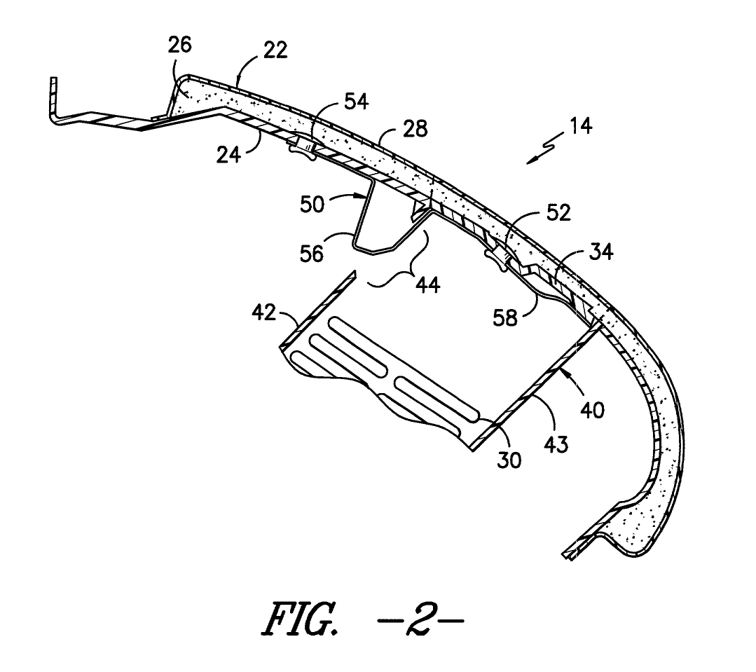

The instrument panel 14 includes an instrument panel cover generally designated as 22. The instrument panel cover 22 extends transversely across and conceals the underlying components of the instrument panel 14, such as HVAC ducts and an underlying air bag module (not shown). As best illustrated in FIG. 2, the instrument panel cover 22 includes a support or substrate panel 24 which is preferably formed from a light weight substantially rigid material such as molded plastic or the like to provide support across the instrument panel cover 22. According to the illustrated embodiment, the instrument panel cover 22 further includes a layer of foam 26 disposed in overlying relation to the rigid substrate panel 24. An outer skin layer 28 forming an outer covering layer is disposed in overlying relation to the foam 26 and the substrate panel 24 as shown. As will be appreciated, the outer skin layer 28 defines an outer show surface visible from within the vehicle interior 12. According to the potentially preferred practice, the outer skin layer 28 forms a substantially smooth covering across the underlying foam 26 and substrate panel 24 as to effectively conceal the location of underlying components. It is to be understood that the instrument panel cover 22 of such a multi-layered configuration may be particularly useful in so called “hidden door” applications incorporating integral displaceable door panels 34 has will be described further hereinafter such that the exit location for an underlying air bag cushion 30 is substantially hidden from an occupant within the vehicle 10 prior to deployment. However, it is contemplated that the present invention is likewise useful in virtually any single layer or multi-layer instrument panel cover arrangement as may be known to those of skill in the art incorporating either integral or separate displaceable door panels. Thus, it is to be understood that the illustrated and described multi-layer instrument panel cover 22 is exemplary only.

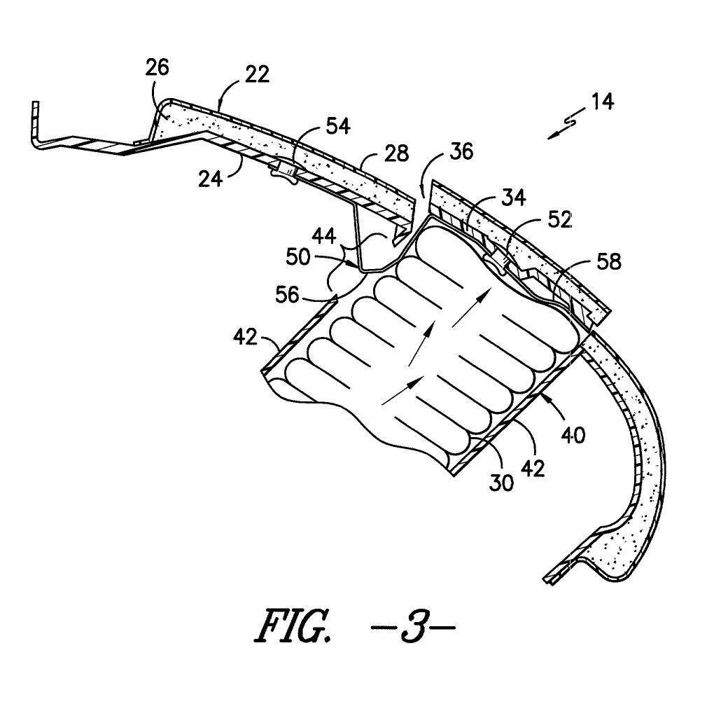

As best illustrated through simultaneous reference to FIGS. 2-4, an inflatable air bag cushion 30 is preferably disposed at a location below the instrument panel cover 22 in fluid communication with a gas emitting inflator (not shown) in a manner as will be well known to those of skill in the art. Disposed in substantially opposing relation to the air bag cushion 30 is a displaceable door panel 34 disposed in covering relation to an air bag deployment opening 36 (FIG. 3) within the substrate panel 24.

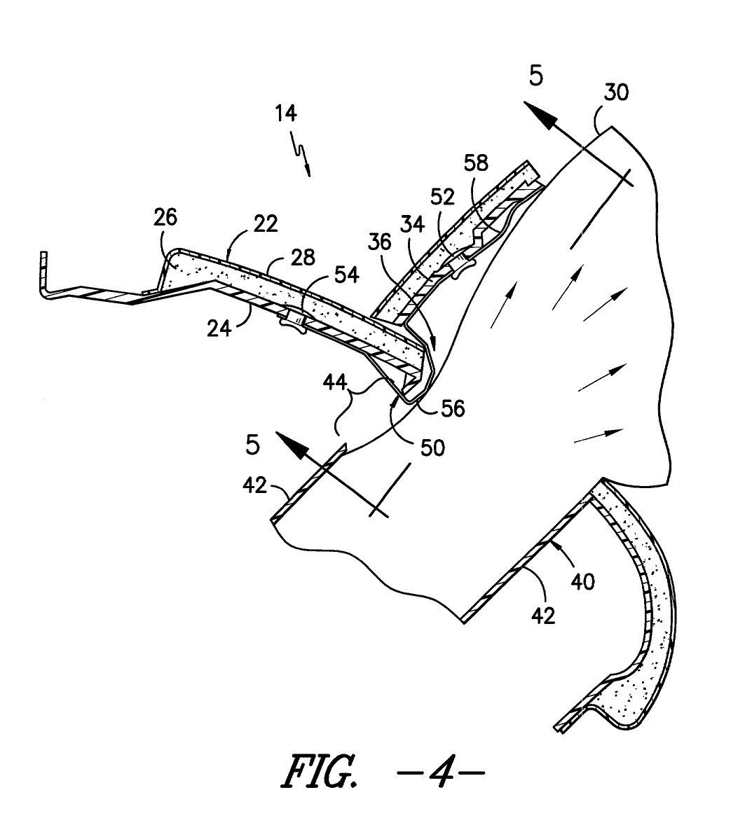

According to one potentially preferred practice, the door panel 34 is integral with the substrate panel 24 formed by cutting a desired breakout pattern across the underside of the substrate panel 24 and at least partially into the overlying foam 26. According to one potentially preferred practice, a breakout pattern may be applied across the underside of the substrate panel 24 in the form of a multiplicity of end to end slots separated short uncut tabs so as to maintain the substantial stability of the substrate panel 24 prior to deployment of the underlying air bag cushion 30. Alternatively, the breakout pattern defining the air bag deployment opening 36 may be in the form of a substantially continuous groove cut into the underside of the substrate panel 24. Preferably, the breakout pattern is formed by controlled material removal techniques such as laser scoring or an ultrasonic knife. If desired, the outer skin layer 28 may be scored across the inner surface thereof in substantial registry with the breakout pattern across the underlying substrate panel 24. Such complementary scoring of the outer skin layer 28 and the substrate panel 24 may promote the clean displacement of the door panel 34 away from the surrounding substrate panel 24 upon outward deployment of the air bag cushion 30 in the manner as illustrated in FIGS. 3 and 4.

It is contemplated that the breakout pattern may be of any suitable geometry including by way of example only, and not limitation, “H” patterns and inverted “U” patterns as will be well known to those of skill in the art. Of course, it is also contemplated that the door panel 34 may be of any other configuration as may be desired including by way of example only, a structural member partially or completely separated from the surrounding panel portions and overlying the air bag deployment opening 36. One such arrangement is disclosed in U.S. Pat. No. 6,045,153 to Sommer (incorporated by reference). In addition, overlying components such as foam and skin may be used or not used as desired.

As illustrated, a guide chute structure 40 preferably extends downwardly away from the substrate panel 24 to establish a bounded travel path for guiding the air bag cushion 30 to the displaceable door panel 34. The guide chute structure is preferably of a substantially box shaped configuration of square or rectangular geometry including a forward guide wall 42, a rear guide wall 43 and two side guide walls (not shown) extending between the forward guide wall 42 and rear guide wall 43.

The guide chute structure 40 is preferably formed integrally with the substrate panel 24 such that the guide walls extend away from the substrate panel 24 from locations immediately outboard of the air bag deployment opening 36 in surrounding relation to the perimeter of the air bag deployment opening 36. As will be appreciated, such an integral downwardly depending chute structure may be formed by molding practices such as injection molding or the like during formation of the substrate panel 24. According to a beneficial aspect of the present invention, the integral guide chute structure 40 ensures the proper orientation between the guide chute structure 40 and the air bag deployment opening 36 while at the same time eliminating a possible source of vibration and noise generation. In addition, the incorporation of an integral guide chute may reduce the cost of manufacture and the complexity of assembly.

As shown, the instrument panel cover 22 preferably incorporates at least one tethering element 50 extending between the door panel 34 and a portion of the substrate panel 24 outboard of the air bag deployment opening 36. As shown in FIG. 2, the tethering element 50 is preferably secured to a position on the door panel 34 by a first machine rivet 52. The tethering element 50 is additionally secured at a location across the substrate panel 24 by a second machine rivet 54. Of course alternative fastening elements such as snap fit attachments and the like as may be known to those of skill in the art may likewise be utilized if desired. As shown, the tethering element 50 is preferably secured to the substrate panel 24 at a location forward of the air bag deployment opening 36 that is, between the door panel 34 and the windshield 16.

According to the illustrated and potentially preferred practice, the tethering element 50 extends through an elongate slotted opening 44 within the forward guide wall 42 disposed along a forward edge of the air bag deployment opening 36. As shown, the tethering element 50 preferably includes an integral length extending loop structure 56 at a location intermediate points of connection to the door panel 34 and the substrate panel 24. Thus, the slotted opening 44 within the guide wall 42 is preferably of sufficient dimension to accommodate passage of the length extending loop structure 56.

The tethering element 50 is preferably formed of a substantially rigid yet plastically deformable material so as to provide a stabilizing influence to the door panel 34 prior to and during the initial stages of deployment of the air bag cushion 30 while nonetheless permitting nondestructive deformation upon hinging displacement of the door panel 34 during the latter stages of deployment. Preferably, the tethering element 50 is a metallic material such as thin gauge steel or aluminum characterized by sufficient rigidity to independently support the mass of the door panel 34 and any overlying foam 26 and skin 28 as may be present. This support may be aided by utilizing a configuration including an extended support arm 58 which extends across a substantial portion of the door panel 34. Placement of the first machine rivet 52 at an intermediate generally central location along the length of the support arm 58 may aid in support by reducing the length of unsupported moment arms.

In operation, as the air bag cushion 30 applies force to the underside of the door panel 34 (FIG. 3) the door panel 34 and overlying segments of the foam 26 and outer skin layer 28 are caused to move outwardly away from the surrounding portions of the instrument panel cover 22. As shown, due to the stability of the door panel 34 and the underlying tethering element 50, during the initial stage of displacement the door panel 34 is projected outwardly away from the surrounding portions of the instrument cover 22 without undergoing substantial hinging rotation. As the air bag cushion 30 pushes further out of the air bag deployment opening 36, the tethering element 50 is extended to its full operative length as the available material within the length extending loop structure 56 is utilized. The door panel 34 is thereafter caused to rotate in a hinging manner to a generally forward position as illustrated in FIG. 4. However, due to the fact that hinging is not initiated until after the door panel 34 has reached an elevated position, the hinging may take place without substantial interference between the door panel 34 and the forward portion of the instrument panel cover 22. Thus, the door panel 34 may be displaced substantially without obstruction from any surrounding structure. The door panel 34 nonetheless remains substantially anchored to the outlying substrate panel 24 by the tethering element 50.

In the event that the tethering element 50 is of the potentially preferred rigid, plastically deformable character such as a metallic structure of aluminum, thin gauge steel, or the like, the tethering element 50 also serves to hold the door panel 34 in place in the post deployment orientation as illustrated in FIG. 4. As will be appreciated, the maintenance of this post deployment position may serve to hold the deployment panel 34 out of the deployment path of the air bag cushion 30 thereby preventing potentially undesirable interference by the door panel 34 during interaction between the air bag cushion 30 and the occupant to be protected. Of course, it is to be understood that the tethering element 50 may also be formed of substantially pliable materials such as fabric or the like if desired although such materials may not provide the addeded advantages of structural support.

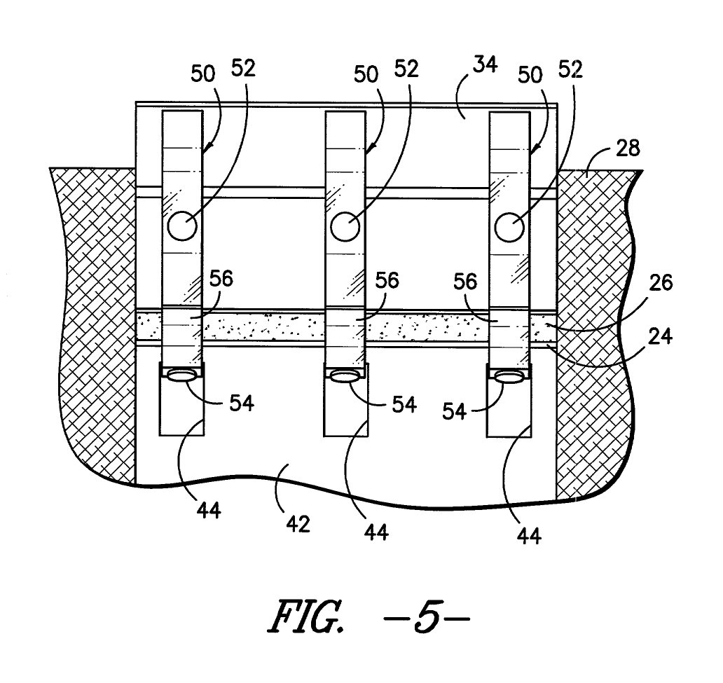

As previously indicated, it is contemplated that a multiplicity of tethering elements 50 may be utilized across the width of the door panel 34. One such arrangement is illustrated in FIG. 5 wherein three substantially discrete tethering elements 50 extend through corresponding slotted openings 44 within the forward guide wall 42 of the guide chute structure 40. In such an arrangement, each of the tethering elements 50 serves to anchor the door panel 32 to the forward portion of the substrate panel 24 in the manner as previously described. It is contemplated that such a multiple tether configuration may permit the use of thinner gauge tethering materials while nonetheless maintaining tethering strength and underlying support. It is further contemplated that such a multiple tether configuration may permit the use of various combinations of tethering elements of different materials such as combinations of tethers of various stiffness levels and/or combinations of stiff and highly pliable tethers in the same cover assembly to achieve desired deployment characteristics.

While the present invention has been illustrated and described in relation to potentially preferred embodiments and practices it is to be understood that such embodiments and practices are illustrative only and that the present invention is in no event to be limited thereto. Rather, it is contemplated that modifications and variations to the present invention will in no doubt occur to those of skill in the art upon reading the upon description and/or through practice of the invention. It is therefore intended that the present invention shall extend to all such modifications and variations which incorporate the broad aspects of the present invention within the full spirit and scope of the following claims and all equivalents thereto.

1. An air bag cover assembly adapted for disposition within an automotive vehicle instrument panel in overlying relation to an underlying inflatable air bag cushion, the cover assembly comprising:
a rigid support panel including an air bag deployment opening for passage of the underlying inflatable air bag cushion therethrough upon inflation of the underlying inflatable air bag cushion;
a displaceable door structure disposed at least partially across the air bag deployment opening within the support panel, the displaceable door structure being displaceable by the air bag cushion upon passage of the air bag cushion through the air bag deployment opening;
a walled guide chute structure integral with the support panel and including a plurality of guide walls extending away from the support panel such that the guide chute structure defines a conduit between the air bag deployment opening and the underlying inflatable air bag cushion, at least one of the guide walls including at least one tether acceptance opening disposed therein; and
at least one tethering element extending through said at least one tether acceptance opening, wherein said at least one tethering element is disposed in affixed relation between the displaceable door structure and a location on the support panel outboard of the air bag deployment opening, said at least one tethering element including an integral expansion structure such that upon displacement of the displaceable door structure by the air bag cushion, said at least one tethering element is extendible to an increased operative length while maintaining an anchoring connection between the displaceable door structure and the support panel.

2. The air bag cover assembly as recited in claim 1, wherein said at least one tethering element consists essentially of a metallic material.

3. The air bag cover assembly as recited in claim 2, wherein said metallic material is selected from the group consisting of: aluminum and steel.

4. The air bag cover assembly as recited in claim 1, wherein said at least one tethering element is disposed in affixed relation between the displaceable door structure and a location on the support panel forward of the air bag deployment opening.

5. The air bag cover assembly as recited in claim 1, wherein the displaceable door structure is integral with the support panel.

6. The air bag cover assembly as recited in claim 5, further comprising a surface covering disposed in overlying relation to the support panel and displaceable door structure.

7. The air bag cover assembly as recited in claim 6, wherein the surface covering comprises an exterior skin layer having a substantially smooth exterior surface and a layer of foam disposed below the exterior skin layer.

8. An air bag cover assembly adapted for disposition within an automotive vehicle instrument panel in overlying relation to an underlying inflatable air bag cushion, the cover assembly comprising:
a rigid support panel including an air bag deployment opening for passage of the underlying inflatable air bag cushion therethrough upon inflation of the underlying inflatable air bag cushion;
a displaceable door structure disposed at least partially across the air bag deployment opening within the support panel, the displaceable door structure being displaceable by the air bag cushion upon passage of the air bag cushion through the air bag deployment opening;
a walled guide chute structure integral with the support panel and including a plurality of guide walls extending away from the support panel such that the guide chute structure defines a conduit between the air bag deployment opening and the underlying inflatable air bag cushion; and
a plurality of tethering elements extending through at least one of the guide walls and being disposed in affixed relation between the displaceable door structure and a location on the support panel outboard of the air bag deployment opening, at least one of the tethering elements being of a substantially rigid, plastically deformable character and including an integral expansion structure such that upon displacement of the displaceable door structure by the air bag cushion, said at least one of the tethering elements is extendible by plastic deformation to an increased operative length while maintaining an anchoring connection between the displaceable door structure and the support panel.

9. The air bag cover assembly as recited in claim 8, wherein said at least one of the tethering elements comprises a rigid support arm disposed in underlying supporting relation to the displaceable door structure.

10. The air bag cover assembly as recited in claim 9, wherein the rigid support arm extends substantially across the displaceable door structure.

11. The air bag cover assembly as recited in claim 10, wherein the rigid support arm is affixed to the displaceable door structure at an intermediate position along the length of the support arm.

12. The air bag cover assembly as recited in claim 8, wherein said at least one of the tethering elements comprises a rigid support arm disposed in underlying supporting relation to the displaceable door structure and wherein said at least one of the tethering elements consists essentially of a metallic material.

13. The air bag cover assembly as recited in claim 12, wherein said metallic material is selected from the group consisting of: aluminum and steel.

14. The air bag cover assembly as recited in claim 8, wherein said at least one of the tethering elements is disposed in affixed relation between the displaceable door structure and a location on the support panel forward of the air bag deployment opening.

15. The air bag cover assembly as recited in claim 8, wherein the displaceable door structure is integral with the support panel.

16. The air bag cover assembly as recited in claim 15, further comprising a surface covering disposed in overlying relation to the support panel and displaceable door structure.

17. The air bag cover assembly as recited in claim 16, wherein the surface covering comprises an exterior skin layer having a substantially smooth exterior surface and a layer of foam disposed below the exterior skin layer.

18. An air bag cover assembly adapted for disposition within an automotive vehicle instrument panel in overlying relation to an underlying inflatable air bag cushion, the cover assembly comprising:
a rigid support panel including an air bag deployment opening for passage of the underlying inflatable air bag cushion therethrough upon inflation of the underlying inflatable air bag cushion;
a displaceable door structure disposed across the air bag deployment opening within the support panel, the displaceable door structure being displaceable by the air bag cushion upon passage of the air bag cushion through the air bag deployment opening;
a walled guide chute structure integral with the support panel and including a forward guide wall disposed at least partially along a forward edge of the air bag deployment opening; and
at least one tethering element of substantially rigid plastically deformable character extending through the forward guide wall in affixed relation between the displaceable door structure and a location on the support panel forward of the air bag deployment opening, said tethering element including a rigid support arm affixed to the displaceable door structure and disposed in underlying supporting relation to the displaceable door structure, said tethering element further including an integral expansion loop structure such that upon displacement of the displaceable door structure by the air bag cushion, said tethering element is extendible by plastic deformation to an increased operative length while maintaining an anchoring connection between the displaceable door structure and the support panel and said tethering element having sufficient post deformation rigidity to support the displaceable door structure in an elevated position relative to the air bag deployment opening following inflation of the air bag cushion.

19. The air bag cover assembly as recited in claim 18, wherein said at least one tethering element consists essentially of a metallic material.

20. The air bag cover assembly as recited in claim 19, wherein said metallic material is selected from the group consisting of aluminum and steel.

21. The air bag cover assembly as recited in claim 18, wherein the displaceable door structure is integral with the support panel.

22. The air bag cover assembly as recited in claim 18, wherein the displaceable door structure is not integral with the support panel.

23. The air bag cover assembly as recited in claim 18, further comprising a surface covering disposed in overlying relation to the support panel and displaceable door structure.

24. The air bag cover assembly as recited in claim 23, wherein the surface covering comprises an exterior skin layer having a substantially smooth exterior surface and a layer of foam disposed below the exterior skin layer.
